(19) United States
(12) Patent Application Publication
(10) Pub. No.: US 2006/0122916 A1
(43) Pub. Date: Jun. 8, 2006

(54) System and method for dynamic e-commerce shopping icons

(76) Inventor: Peter Kassan, Dobbs Ferry, NY (US)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 11/254,067

(22) Filed: Oct. 19, 2005

Related U.S. Application Data
(60) Provisional application No. 60/619,976, filed on Oct. 19, 2004.
(60) Provisional application No. 60/685,128, filed on May 27, 2005.

(51) Int. Cl. G06F 17/30

(52) U.S. Cl. 705/27

(57) ABSTRACT

Disclosed is an easily identifiable flyover icon placed on or near a visual depiction of an item to be ordered from an e-commerce Web site. The icon calls attention to itself as the mechanism by which a user is to place the item into a shopping cart. The icon provides immediate feedback that the item is ready to be placed in the cart, that the item is being placed in the cart, and that the item has been placed in the cart.

### CROSS REFERENCE TO RELATED APPLICATIONS

This application claims priority to U.S. Provisional Application No. 60/619,976, filed Oct. 19, 2004, the entirety of which is incorporated herein by reference.

### FIELD OF THE INVENTION

The present invention relates to computer icons and more particularly to a dynamic icon that is operable for use in e-commerce applications.

### BACKGROUND OF THE INVENTION

An important aspect of any computer system is the interface that allows a user to input commands and data, and to receive the results of operations performed within the computer. In the area of personal computers, the graphical user interface (GUI) has become almost ubiquitous. These GUIs employ various visual elements to assist the user in managing information within the computer and on Web pages. A fundamental aspect of the GUI is the icon. An icon comprises an image that is displayed on the desktop, or within another window, and represents a particular object or initiates a specific action. For instance, an icon may initiate a purchase routine, act as a hyperlink, represent a file containing data or a program, be employed to represent a window that has been closed or minimized, container objects such as folders, and computer resources such as disk drives and printers. Selecting an icon, for example by means of a mouse or other cursor control device, enables the user to access the information or resource represented by that icon.

When users access the Internet to look for and purchase items, a key step in the interaction is actually purchasing the desired item. There is no standard for adding an item to the user's shopping receptacle or shopping basket. A user has to search for the “purchase” button to make a purchase. Additionally, once a user finds the purchase button, each Web page behaves differently to show an item was added to the shopping basket.

One popular Web site, Amazon.com®, sells products via the Internet. On Amazon.com®, when a user decides to purchase an item, first, the user must find the button for placing an item in the user's cart. The button for placing items in the user's cart on Amazon.com® appears on the upper right hand side of the Web page below the Amazon.com® menu bar. Other Web sites place the button for placing an item in the user's cart in other places on the page so a purchaser has to search the page to purchase an item. If a user gets frustrated searching for the means to buy the desired item in most instances, the sale is lost.

Turning again to Amazon.com®, and most other Web pages, once a user succeeds in finding the button for placing items in the user's cart, the user is taken to another page. On this page, other items may be displayed, as selected by the Web site, and the cart is displayed. However, it is difficult for the user to return to the item just added to the cart.

Additionally, other than changing the page being viewed, there is no visual cue that an item is added to the cart. Once a user clicks the purchase button, the user has no way on knowing the state of the system. Until the user receives the revised web page or a confirmation email, the user does not know if the item has been added to the cart.

Every time a user adds an item to his or her shopping cart, a new page is displayed showing the cart contents. This adds a significant strain on the network in data transmission, and when the shopping cart Web page is dynamically generated, significantly loads down a server hosting the web page being provided.

### SUMMARY OF THE INVENTION

The present invention solves the problems in the prior art by providing an improved icon that depicting adding an item to the shopping receptacle. In particular, the improved icon calls attention to itself as the mechanism by which the user is to place an item into the shopping cart and to provide immediate and graphical feedback that the item has been placed in the cart. In one embodiment, the user is not presented with a shopping cart page.

According to one aspect of the invention, an easily identifiable flyover icon is placed on or near a visual depiction of an item to be ordered from an e-commerce Web site. The icon is a variation on an icon typically used by the Web site to indicate the shopping receptacle such as a shopping cart, shopping bag, shopping basket, or the like. The icon of the present invention preferably represents the placement of an item into the receptacle using standard graphical devices such as one or more arrows, other conventional suggestions of motion such as are used in cartoons and other drawings, and actual animation. Placement is represented using standard graphical devices such arrows, other suggestions of motion such as are those used in cartoons and other drawings, animation, and the like.

According to another aspect of the invention, after the user clicks on the icon, the depiction of the icon or its background is altered to indicate the state of the system. In other words, the icon is used to designate activity taking place in the system. For example, during purchase, the colors in the depiction of the icon may become more or less saturated, or change entirely or the icon may be altered from three-dimensional to two-dimensional.

If the icon is animated, the animation suggests movement of the arrow toward the shopping receptacle. The animation consists of the arrow moving toward the shopping receptacle, the tail of the arrow gradually shortening or becoming less evident, one or more generic objects (suggesting items to be selected) moving into the shopping receptacle, or generic objects jumping directly into the shopping receptacle, without any apparent intermediate locations, or the like.

When the user clicks on the icon to place the item or items indicated into the shopping receptacle, the user receives feedback in one or more of the following ways: a sound is made, the icon changes, the item's background changes, a new graphical element is introduced into the icon, or the like.

Following the user clicking on the icon, the appearance of the icon changes in one or more ways. The arrow or other graphical suggestion of motion is removed entirely or made less evident, by lightening its color, making it apparently transparent, or the like. If the any part of the icon was depicted against a distinctive background, the appearance of that background may change, such as color, outline, or the like. If part of the icon was depicted as a shopping receptacle, the color of the shopping receptacle changes, the appearance of the shopping receptacle changes, if the icon showed one or more items apparently outside the shopping receptacle, it no longer does so, the shopping receptacle appears to contain one or more items in one or more ways the item or items are wholly or partially visible via the open top of the receptacle, the item or items are wholly or partially visible through holes in the shopping receptacle, the item or items are partially visible through the apparently transparent surface of the shopping receptacle, the item or items in the receptacle is suggested by the appearance of one or more bulges, outlines, sagging, or other conventional depiction of a full container, the number of item or items in the receptacle is shown in or near the receptacle, or the like.

### DESCRIPTION OF THE FIGURES

FIG. 1 is a depiction of a Web page embodying the inventive icon;

FIG. 2 depicts one embodiment of the inventive icon in its quiescent state;

FIGS. 3A-3C depict one embodiment of the inventive icon in its activated state;

FIGS. 4A-4G depict one embodiment of the inventive icon in its performance state;

FIG. 5 depicts one embodiment of the inventive icon in its updated quiescent state;

FIGS. 6A-6L depict adding an item to a shopping cart;

FIG. 7 depicts various icons for use with the inventive concept; and

FIG. 8 depicts a system according to the present invention.

### DETAILED DESCRIPTION OF THE INVENTION

The following discussion describes various embodiments of the present invention. Many of the features described below are optional and can be added or removed without departing from the spirit of the invention. As described below, a virtual shopping receptacle is included and may further include various techniques for selection, such as shopping carts, wish lists, bridal registries, or the like.

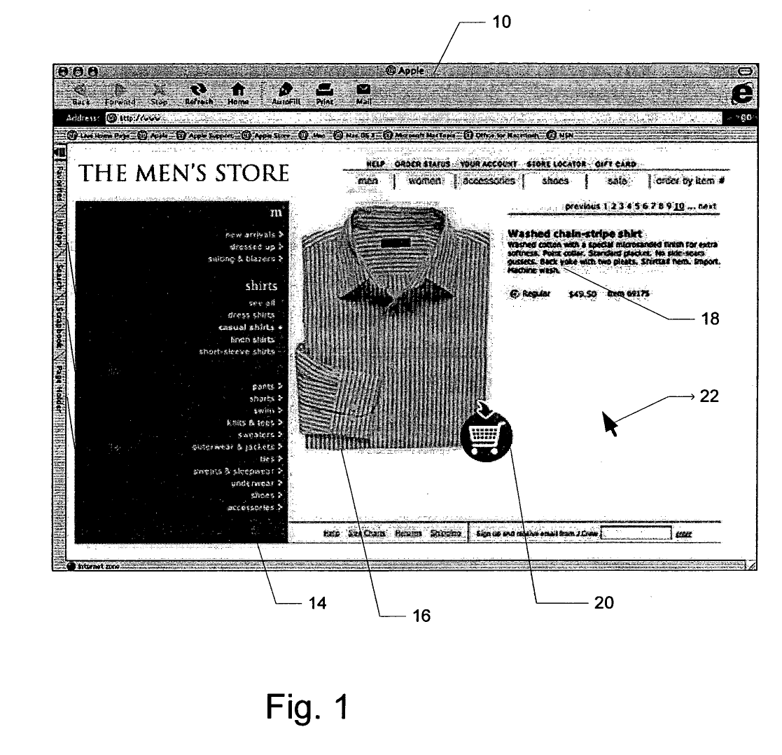

FIG. 1 depicts a Web page having an icon according to the present invention in its quiescent state. Web page 10, hosted on a server, includes items such as navigation tabs 12, an index of goods 14, a specific item 16, a description 18 of the item 16, and an icon or button 20 for initiating the purchasing process. Icon 20 is located on or near item 16. The user does not have to search the Web page to find the icon 20 to place the item in a shopping cart because preferably, it is adjacent to the item 16. In another embodiment, icon 20 overlaps item 16. In yet another embodiment, icon 20 is near the description 18.

FIG. 1 shows only one item 16. However, multiple items can be displayed on web page 10. In one embodiment, each item has its own icon or button 20 for initiating the purchasing process. Any changes to icon or button 20 for a first item would not affect an icon associated with another item. In another embodiment, multiple items are displayed with only a single icon or button 20 for initiating the purchasing process. In this embodiment, the item to be purchased is dragged to the icon.

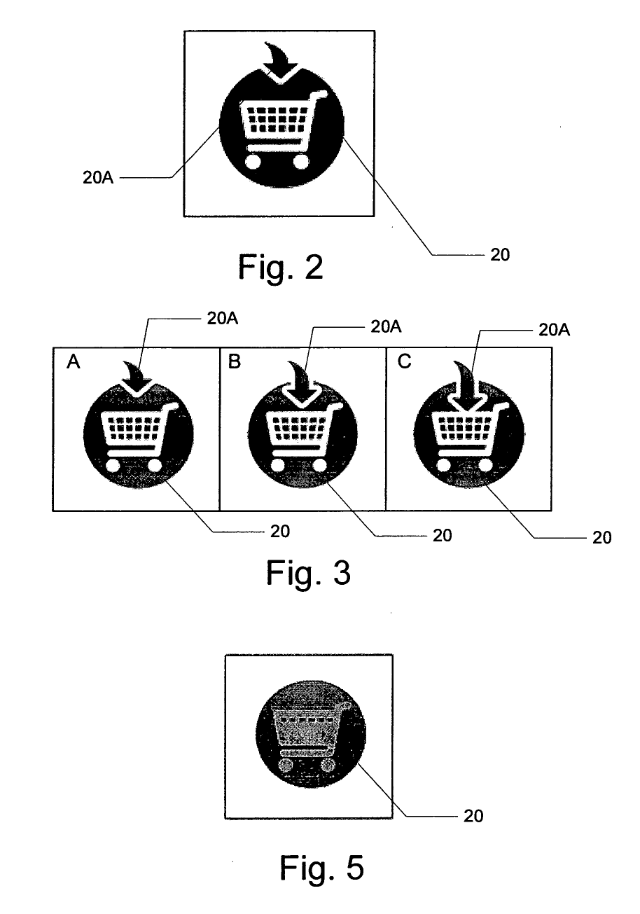

When Web page 10 first loads in a user's browser, icon 20 is in its quiescent state. In the quiescent state, icon 20 is static, as depicted in FIG. 2. Icon 20 preferably resembles a shopping cart or other easily recognizable shopping receptacle. Icon 20 preferably has an arrow 20A or other designator indicating that it is used for adding the item to the shopping cart. In its quiescent state, icon 20 and arrow 20A are a first color.

In one embodiment, an item or items to be placed into the shopping receptacle is included in the icon 20. The item or items are small depictions of the actual item or items, or a generic object or objects. For example, as shown in FIG. 1, when the item is a shirt, the small item or items are depicted in the shape a shirt. In another embodiment, the small depiction may also depict or suggest the actual color or pattern of the item being viewed.

When the user moves cursor 22 over icon 20, icon 20 enters its second state, an activated state as shown in FIG. 3. In the activated state, icon 20 changes in appearance by changing in color, size, animates, or the like. In a preferred embodiment, when cursor 22 moves on or near icon 20, icon 20 changes by having arrow 20A extending to the shopping cart as shown in FIGS. 3A-3C. In another embodiment, the arrow 20A begins moving and icon 20 and arrow 20A change color. Alternatively, icon 20 and arrow 20A change to different colors and arrow 20A cycles through at least two different colors to indicate that icon 20 is used to place the item being viewed into the shopping cart. It should be noted that arrow 20A, or other designator, can be animated and simultaneously change colors to designate the activated state. In place of an arrow, a generic box, miniature item 16, or other animation can be used to simulate items moving towards the cart.

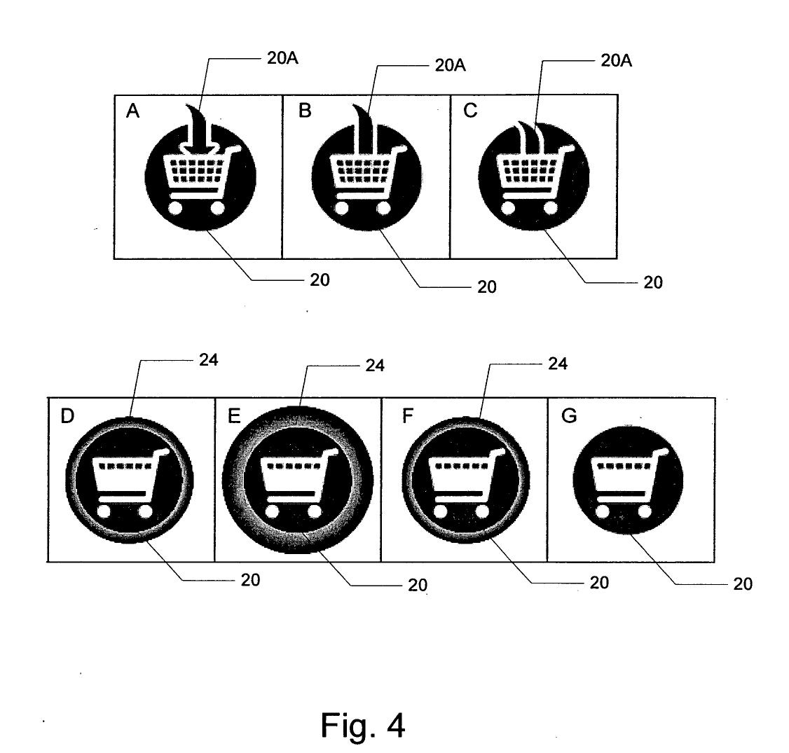

When the user clicks icon 20 in the activated state, the icon enters a third state, the purchase, or action state. In one embodiment, the user receives an audio cue that icon 20 was clicked. In this state, the icon's designated activity such as adding the item to the user's cart or registry takes place. As depicted in FIGS. 4A-4G, the icon depicts placing an item in the cart. The user may also enter the action state by placing an item into the cart by “dragging and dropping” the larger depiction or small depiction of the item into the cart.

As shown in FIG. 4, in a preferred embodiment, arrow 20A continues the movement began in the activated state. In the action state, in a first embodiment, the arrow 20A continues its movement into the shopping cart as shown in FIGS. 4A-4C. In one embodiment, the icon 20 changes color to designate a state change. Once the item is added to the user's cart during the purchase routine, the icon's animation changes. The icon 20 develops a ring 24, flashes, emits fireworks, expands, or has some other visual change to denote the purchase is proceeding. Additionally, cart 26 changes to depict that it is full. Once the purchase routine is complete, the icon animation ceases as shown in FIG. 4G.

In the preferred embodiment, when a user clicks icon 20 to initiate the purchase routine, arrow 20A begins moving into the basket as shown in FIGS. 4A-4C. While the arrow is moving into the basket, the browser is sending a request to the server hosting the web page 10 to add item 16 to the user's shopping cart. Once the browser receives acknowledgment that the item has been placed in the user's shopping cart, a starburst or other visual indicator is displayed, as shown in FIGS. 4D-4F. Additionally, the cart preferably is shown as being full. Once the transaction is complete, as shown in FIGS. 4G, the icon returns to a quiescent state showing the cart as full.

To add additional items to the shopping cart, the user clicks the icon or drags the item into the cart for the quantity of the item desired. Alternatively, a pulldown menu is used to vary the quantity of the item purchased. Even if the user has already placed an item or items into the shopping receptacle and the appearance of the icon has changed, the user can continue to click on the receptacle to add the same item and the system responds by providing appropriate feedback. If the number of items is depicted in or near the receptacle, the number is altered appropriately to display the current quantity of the selected item in the cart.

In one embodiment, once the user clicks on the icon 20, the depiction of the item 16 or its background is also altered. For example, the colors in the depiction of the item 16 may become more or less saturated; if the item was depicted in color, it may be depicted in black-and-white, grayscale, or a smaller number or range of colors; the depiction of the item may be less detailed; the depiction of the item may be altered from three-dimensional to two-dimensional; the depiction may be altered from photographic to cartoon; text indicating that the item was purchased or selected (such as, for example, “SOLD”, “SELECTED”, “PURCHASED”, “TAKEN”, etc.) may appear near or over the depiction of the item. The appearance of the background behind the depiction of the item changes, such as in color, outline, or the like.

After the transaction is complete and item 16 is added to the user's cart, the icon 20 enters a fourth state, an updated quiescent state. In the fourth state, as shown in FIG. 5, the cart is preferably depicted as being full. Additionally, in a preferred embodiment, icon 20 changes color. In one embodiment, until the purchase is complete, i.e., the user completes a checkout process, whenever Web page 10 is viewed icon 20 is displayed in the fourth state indicating that item 16 has been added to the user's cart. In the preferred embodiment, after icon 20 enters the fourth state, it does not enter either of the first two states. In one embodiment, there is a button to get a review of the items in the cart. Alternatively, once icon 20 enters the fourth state, clicking the icon takes the user to a cart review page.

If the user removes the selection of the item from the shopping cart, the graphic appearance of the item and its associated selection icon 20 reverts to the original quiescent state, shown in FIG. 2.

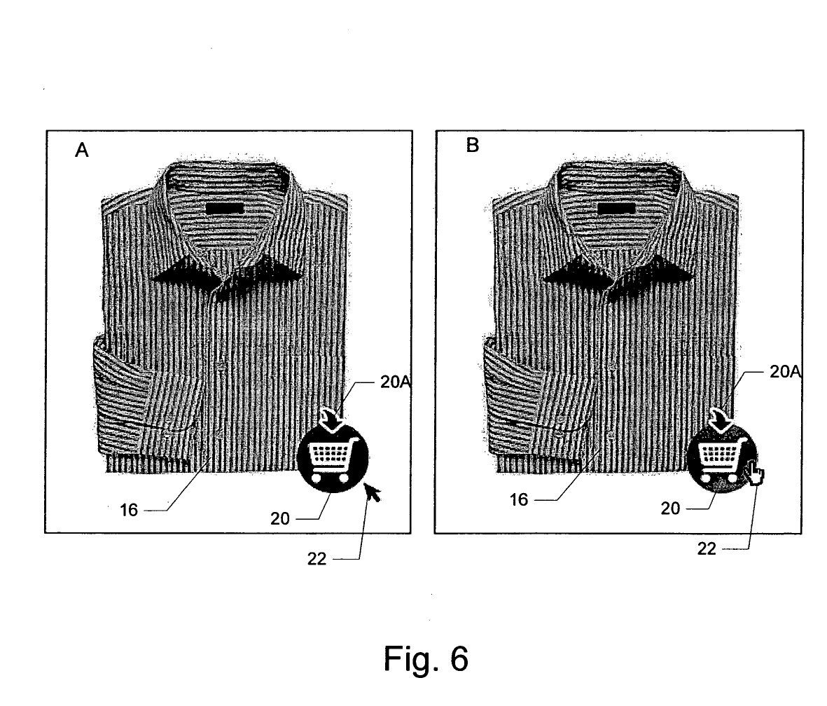

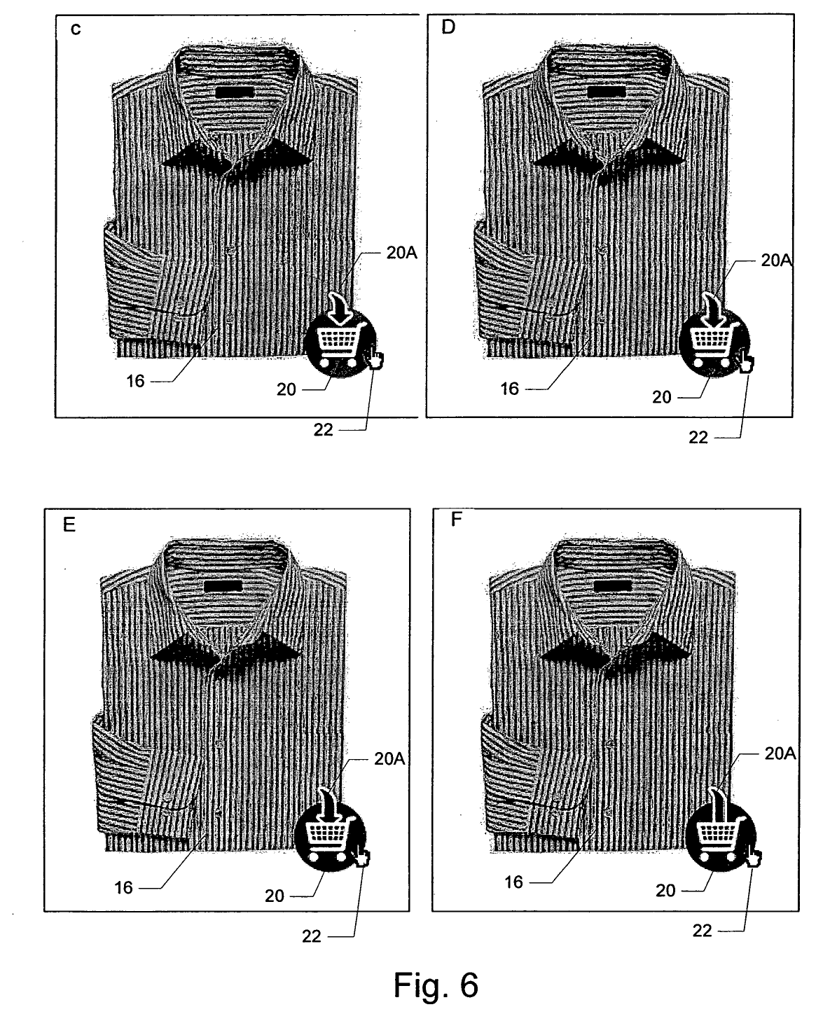

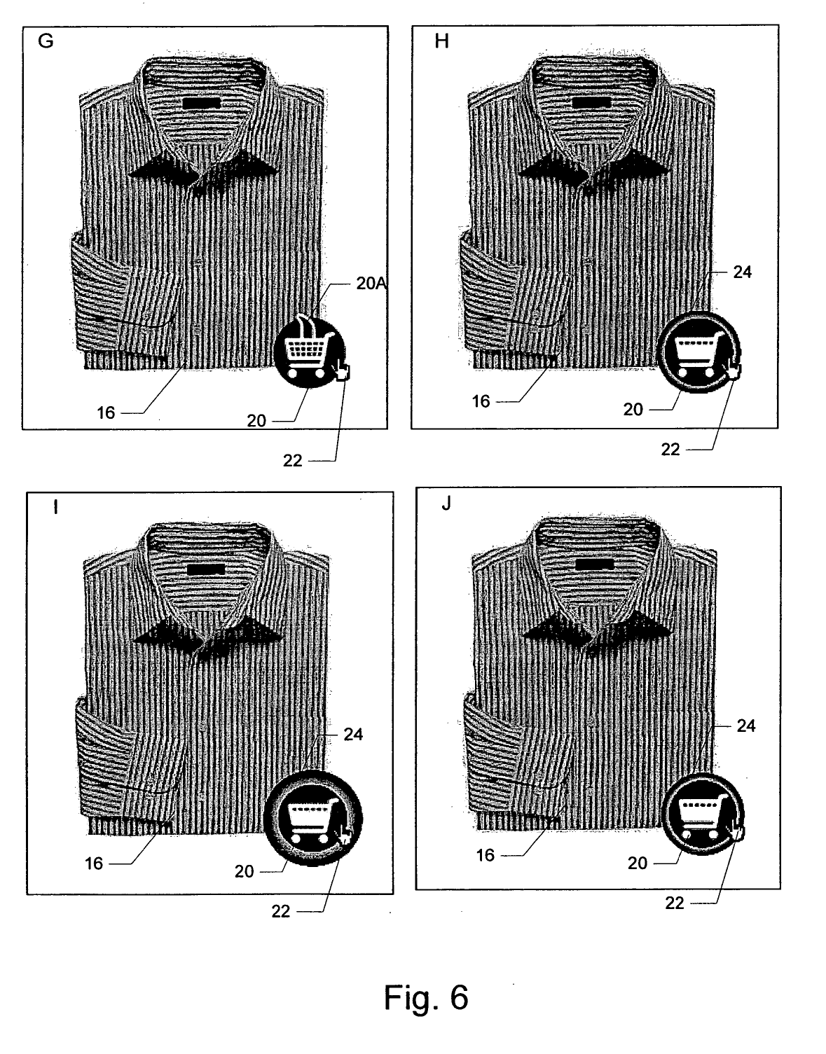

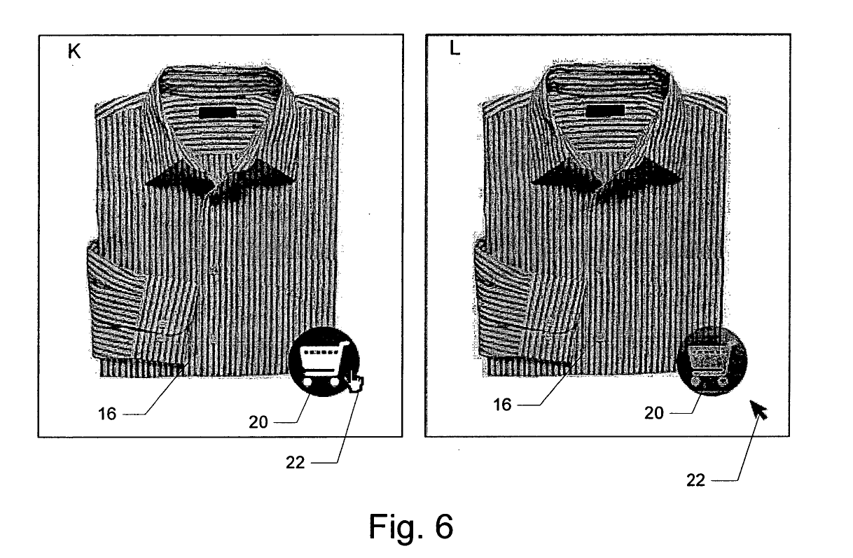

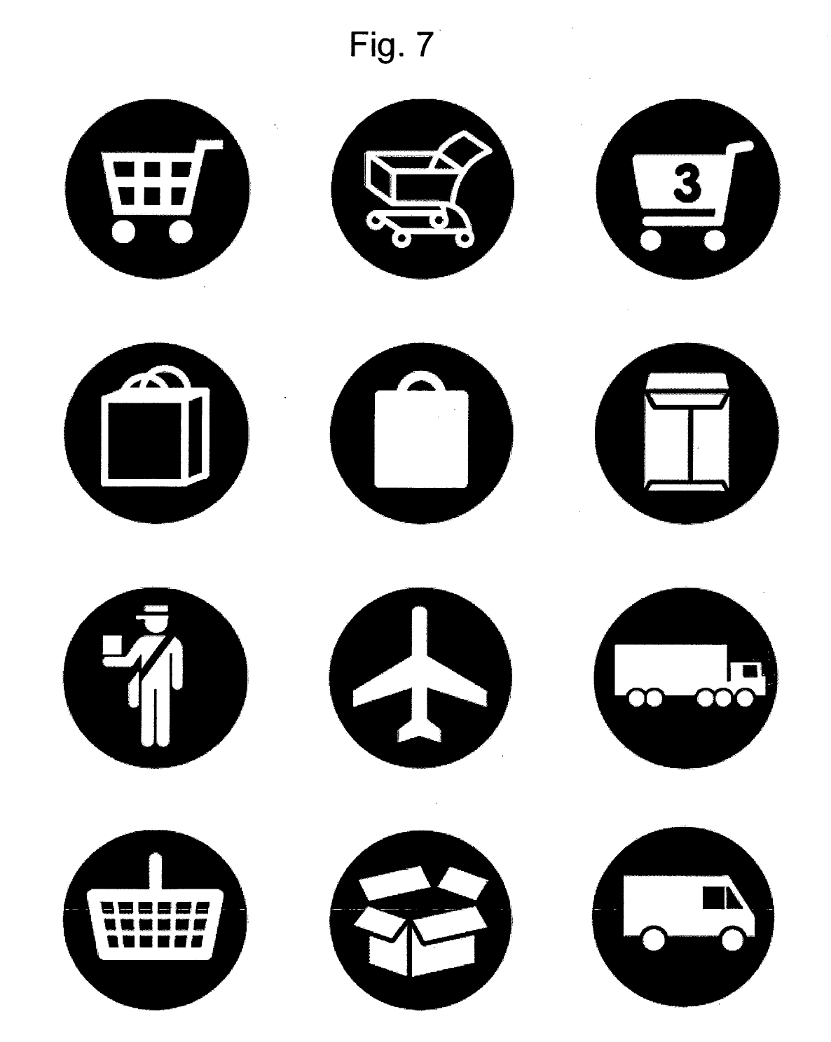

FIGS. 6A-6L depict adding an item 16 to a shopping cart according to a preferred embodiment of the invention. As shown, FIG. 6a depicts icon 20 in its quiescent state. When cursor 22, overlaps or comes within a specified distance to icon 20, icon 20 enters the second state. As discussed above, when icon 20 enters the second state, it visually entices a user to place an item into the cart as shown in FIGS. 6A-6D. If the user then clicks on the icon 20 or drags item 16 into the cart, the icon enters the third state, shown in FIGS. 6E-6K, and the cart is depicted as being filled. Finally, once the item is added to the cart, the second quiescent state is entered as shown in FIG. 6L.

It should be noted that the used is apprised of the state of the system at each step. As shown in FIG. 6A, the system is in a quiescent state awaiting action by a user. When the user's cursor 22 approaches the flyover icon 20 the icon changes, as shown in FIGS. 6B-6D, notifying the user that icon 20 is the means to add item 16 to the user's cart. In a preferred embodiment, when the user clicks icon 20 a message is sent to add item 16 to the user's cart. Icon 20 visually displays that the item is being added to the cart, as shown in FIGS. 6E-6G, thereby notifying the user that the add item message has been sent. Once the system adds the item to the user's cart, a second cue is presented to the user thereby confirming that the item was added to the cart, as shown in FIGS. 61-6K. Thus, the user is, in a preferred embodiment, notified of the system state at each step of the process.

It should be noted that web page 10 requires fewer resources than a prior art e-commerce Web pages. In the prior art, when a user selected an item for purchase, a separate Web page was displayed to indicate the state of the system. According to the present invention, only the icon changes during the purchase experience to indicate a change of state. In this manner, network traffic is minimized because information regarding the icon state is transmitted instead of an entire Web page. Additionally, the user is presented with immediate feedback that an item is being placed in the cart and visual display provides feedback regarding the state of the system. In an alternative embodiment, after the item is added to the cart, a separate page to verify placement of an item in the user's cart can be presented to the user.

As shown in FIG. 7, various receptacles can be used. Shopping receptacles include a shopping cart, a shopping bag, a shopping basket, a box, an envelope, a truck, a plane, or the like. In one embodiment, multiple icons appear on or near each item. Each icon represents not only the user's shopping cart, but also the preferred shipping method. In other words, a mailbox can appear for standard shipping and an airplane can appear for overnight or expedited delivery.

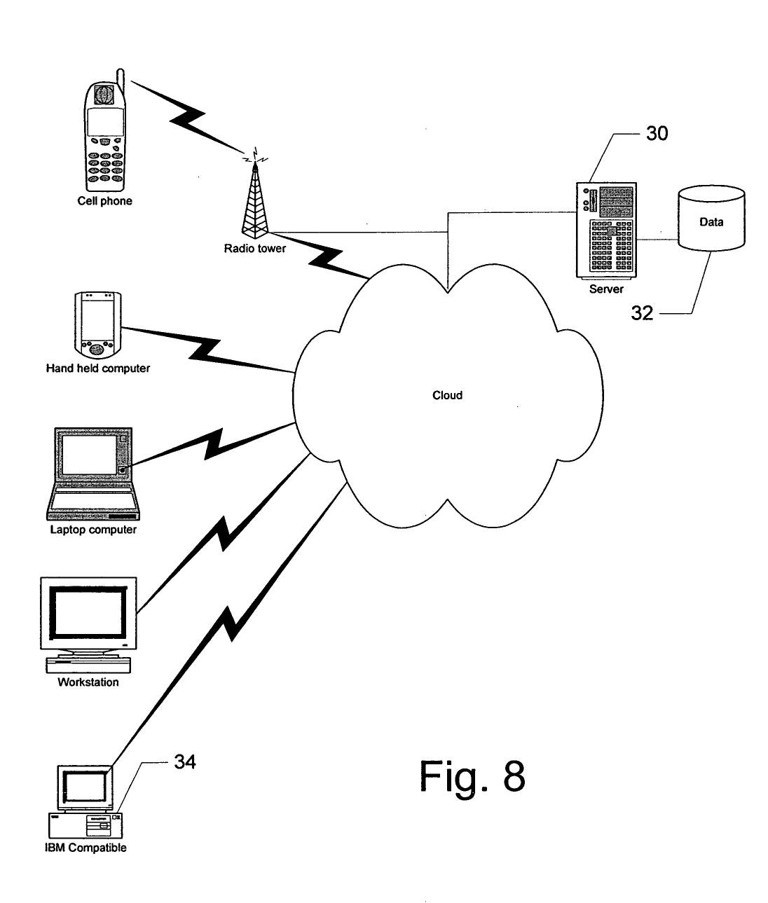

The icon operates in a system where the icon is responsive to a user's activity on a web page. A typical system is shown in FIG. 8. Although shown as a distributed network, the multistate icon can be used in a centralized system. The system includes an icon display code module, stored in a computer readable medium, to process a plurality of icon display instructions associated with the web page. In one embodiment, the icon display code module and web page 10 are hosted by server 30. When a user 34 accesses web page 10, a request is sent to server 30 to provide web page 10 and its associated active icon. As the user 34 interacts with web page 10, icon display instructions are processed in response to user's activity. In one embodiment, the activity includes selecting an item on the web page 10. As discussed above, the icon then enters a plurality of states. The icon display code module provides the distinct icon states. The states include a first quiescent state indicating no activity relative to the icon, a second active state indicating that an icon is available for selection; and a third action state indicating that a process associated with the icon is proceeding.

While this invention has been described by reference to preferred embodiments, it should be understood that numerous changes could be made within the spirit and scope of the inventive concepts described. Accordingly, it is intended that the invention not be limited to the disclosed embodiment, but that it have the full scope permitted by the language of the following claims.

What is claimed is:

1. A system for providing a multistate icon responsive to activity on a web page, comprising:
a web page server containing instructions and data that provide functionality of the web page; and
an icon display module stored on the web page server, the icon display module operable to process a plurality of icon display instructions associated with the web page, the processing of the plurality of icon display instructions being responsive to activity on the web page, wherein the activity includes selecting an item on the web page, wherein the icon display code module provides at least three distinct icon states for an icon displayed on the web page.

2. The system for providing a multistate icon responsive to activity on a web page as recited in claim 1, wherein the icon is displayed in proximity to the item.

3. The system for providing a multistate icon responsive to activity on a web page as recited in claim 1, wherein the icon is displayed overlaying the item.

4. The system for providing a multistate icon responsive to activity on a web page as recited in claim 1, wherein the web page is an electronic commerce web page and wherein the icon represents a receptacle for facilitating purchase of the item on the web page.

5. The system for providing a multistate icon responsive to activity of a web page as recited in claim 1, wherein the least three distinct icon states further comprise:
a first state indicating no activity relative to the icon;
a second state indicating that an icon is available for selection; and
a third state indicating that a process associated with the icon is proceeding.

6. The system for providing a multistate icon responsive to activity of a web page as recited in claim 5, wherein the web page is an electronic commerce web page, wherein the icon represents a receptacle for facilitating the purchase of the item on the web page, wherein the second state indicates that a user has positioned a cursor on or near the icon, and wherein the third state indicates that the user has activated the icon to purchase the item.

7. The system for providing a multistate icon responsive to activity of a web page as recited in claim 5, wherein the second state further comprises:
a first visual modification to the icon, the visual modification including at least one of a color change, animation, and size.

8. The system for providing a multistate icon responsive to activity of a web page as recited in claim 5, wherein the third state further comprises:
a first visual modification to the icon indicating that the icon has been used to select an item on the web page; and
a second visual modification to the icon indicating that the item has been selected.

9. The system for providing a multistate icon responsive to activity of a web page as recited in claim 8, wherein the web page is an electronic commerce web page, wherein the icon represents a receptacle for facilitating the purchase of the item on the web page, wherein the first visual modification to the icon indicates a user has attempted to place the item in the receptacle, and wherein the second visual modification indicates that the item has successfully been placed in the receptacle.

10. The system for providing a multistate icon responsive to activity of a web page as recited in claim 5, further comprising:
a fourth state indicating that the process associated with the icon is completed.

11. The system for providing a multistate icon responsive to activity of a web page as recited in claim 10, wherein the web page is an electronic commerce web page, wherein the icon represents a receptacle for facilitating purchase of the item on the web page, and wherein the fourth state indicates that the receptacle contains at least one item.

12. A method for providing a user of web page with a visual indication of the state of the web page, the method comprising:
displaying the web page to the user; and
displaying an the icon to the user, wherein the icon is displayed in at least three distinct states indicating at least three distinct states of the web page.

13. The method as recited in claim 12, further comprising displaying the icon in proximity to an item on the web page.

14. The method as recited in claim 12, further comprising displaying the icon overlaying an item on the web page.

15. The method as recited in claim 12, wherein the web page is an electronic commerce web page and wherein the icon represents a receptacle for facilitating the purchase of an item on the web page.

16. The method as recited in claim 12, wherein displaying of the at least three distinct states further comprise:
displaying the icon in a first state indicating no activity relative to the icon;
displaying the icon in a second state indicating that an icon is available for selection; and
displaying the icon in a third state indicating that a process associated with the icon is proceeding.

17. The method as recited in claim 16, wherein the web page is an electronic commerce web page, wherein the icon represents a receptacle for facilitating the purchase of an item on the web page, the method further comprising:
displaying the icon in the second state when a user has positioned a cursor on or near the icon; and
displaying the icon the third state when the user has activated the icon to purchase the item.

18. The method as recited in claim 16, wherein the displaying of the icon in the second state further comprises:
visually modifying the icon, the visual modification including at least one of a color change, animation, and size.

19. The method recited in claim 16, wherein the displaying of the icon in the third state further comprises:
performing a first visual modification to the icon to indicate that the icon has been used to select an item on the web page; and
performing a first visual modification to the icon to indicate that the item has been selected.

20. The method as recited in claim 19, wherein the web page is an electronic commerce web page, wherein the icon represents a receptacle for facilitating the purchase of the item on the web page, wherein the first visual modification is performed in response to a user attempting to place the item in the receptacle, and wherein the second visual modification is performed when the item has successfully been placed in the receptacle.

21. The method as recited in claim 16, further comprising:
displaying the icon in a fourth state indicating that the process associated with the icon is completed.

22. The method as recited in claim 21, wherein the web page is an electronic commerce web page, wherein the icon represents a receptacle for facilitating purchase of an item on the web page, and wherein the fourth state indicates that the receptacle contains at least one item.

23. A method for providing a user of a web page with the state of a computer based system hosting the web page, the method comprising:
providing a plurality of users with access to the computer-based system;
presenting to the user an information display screen including at least one status indicator icon and at least one item, the status indictor icon having at least one control function associated therewith, and the status indicator icon being in a first state indicating a first state of the computer based system;
changing the visual appearance of the status indicator icon to a second state to indicate a second state of the computer based system based on the user's activity on the information display screen, the second state of the status indicator icon representing the user's activity on the information display screen; and
changing the visual appearance of the status indicator icon to a third state to indicate a third state of the computer based system based on the user's selecting the item, the third state of the status indicator icon representing the user's selection of the item.

24. The method as recited in claim 23, wherein changing the visual appearance of the status indicator icon to a second state further comprises animating the status indicator icon.

25. The method as recited in claim 23, wherein changing the visual appearance of the status indicator icon to a third state further comprises:
animating the status indicator icon in response to the user selecting the item, the animation indicating the item is being added to a list in the computer based system; and
further modifying the status indicator icon to indicate that the item has been successfully added to the list in the computer based system.

26. The method as recited in claim 23, wherein changing the visual appearance of the status indicator icon to a second state further comprises partially animating the status indicator icon.
